(19) United States
(12) Patent Application Publication
(10) Pub. No.: US 2025/0148365 A1
(43) Pub. Date: May 8, 2025

(54) Continuous Training of Machine Learning Models on Changing Data

(71) Applicant: Google LLC, Mountain View, CA (US)

(72) Inventors: Dirk Ryan Padfield, Seattle, WA (US); Matthew Sharifi, Kilchberg (CH)

(21) Appl. No.: 18/835,869

(22) PCT Filed: Feb. 3, 2022
(86) PCT No.: PCT/US2022/015035

§ 371 Date: Aug. 5, 2024

(51) Int. Cl. G06N 20/00

(52) U.S. Cl. CPC G06N 20/00

(57) ABSTRACT

Provided are systems and methods for continuous training of machine learning (ML) models on changing data. In particular, the present disclosure provides example approaches to model training that take advantage of constantly evolving data that may be available in various ancillary systems that contain large amounts of data, but which are not specific to or dedicated for model training.

### FIELD

The present disclosure relates generally to improvements in training of machine learning models. More particularly, the present disclosure relates to systems and methods for continuous training on changing data.

### BACKGROUND

Machine learning (ML) models (e.g., so-called “deep” neural networks) are increasingly used to solve a wide range of tasks in an array of systems. Training ML models typically requires a large amount of data and, therefore, a typical approach is to collect and store a large amount of data dedicated solely for the purpose of training the model. This challenge of collecting large amounts of data is amplified when training large or “deep” models, which typically contain many millions of parameters. Collection and storage of a dedicated reservoir of large amounts of training data can be infeasible or at least very costly in terms of computer resource usage such as computer memory usage and also in terms of human time and effort to provide labels for the training data.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to train machine learning models on changing data. The method can be performed for one or more update iterations. The method includes sampling, by a computing system comprising one or more computing devices, from a pool of data associated with one or more ancillary systems to generate a current set of training data. The method includes training, by the computing system, a machine learning model on the current set of training data to generate an updated model. The method includes evaluating, by the computing system, a performance of the updated model relative to a current set of testing data. The method includes performing, by the computing system, a comparison of the performance of the updated model relative to the current set of testing data with a respective performance of one or more other machine learning models on the current set of testing data or one or more past sets of testing data. The method includes selecting, by the computing system, either the updated model or one of the one or more other machine learning models for deployment based on the comparison of the performance of the updated model relative to the current set of testing data with the respective performance of the one or more other machine learning models on the current set of testing data or the one or more past sets of testing data.

Another example aspect of the present disclosure is directed to a computing system for training machine learning models on changing data. The computing system includes one or more processors and one or more non-transitory computer-readable media that collectively store instructions that, when executed by the one or more processors, cause the computing system to perform operations for each of one or more update iterations. The operations include sampling, by the computing system, from a pool of data associated with one or more ancillary systems to generate a current set of training data. The operations include training, by the computing system, a machine learning model on the current set of training data to generate an updated model. The operations include evaluating, by the computing system, a performance of the updated model relative to a current set of testing data. The operations include performing, by the computing system, a comparison of the performance of the updated model relative to the current set of testing data with a respective performance of one or more other machine learning models on the current set of testing data or one or more past sets of testing data.

Another example aspect of the present disclosure is directed to one or more non-transitory computer-readable media that collectively store instructions that, when executed by a computing system, cause the computing system to perform operations for each of one or more update iterations. The operations include sampling, by the computing system, from a pool of data associated with one or more ancillary systems to generate a current set of training data. The operations include training, by the computing system, a machine learning model on the current set of training data to generate an updated model. The operations include evaluating, by the computing system, a performance of the updated model relative to a current set of testing data. The operations include performing, by the computing system, a comparison of the performance of the updated model relative to the current set of testing data with a respective performance of one or more other machine learning models on the current set of testing data or one or more past sets of testing data.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a flow chart diagram of an example method to perform training and evaluation of machine learning models on continuously changing training data according to example embodiments of the present disclosure.

FIG. 2A depicts a block diagram of an example computing system according to example embodiments of the present disclosure.

FIG. 2B depicts a block diagram of an example computing device according to example embodiments of the present disclosure.

FIG. 2C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to systems and methods for continuous training of machine learning (ML) models on changing data. In particular, the present disclosure provides example approaches to model training that take advantage of constantly evolving data that may be available in various ancillary systems that contain large amounts of data, but which are not specific to or dedicated for model training. Specifically, rather than generating fixed sets of training and evaluation/testing data for a given model, example systems described herein build models that are continuously trained and updated in such a way that the underlying data is not accessible and is implicitly wiped out or deleted. This enables training of large models while respecting data handling obligations such as data usage or privacy settings or controls, as well as training models where the underlying training data is in flux. The proposed systems also enable the training of very large models in which the information they are trained on continues to be freshly updated and/or extended.

More particularly, typical approaches for training ML models include collecting and storing a large amount of data dedicated solely for the purpose of training the model. Collection and storage of a dedicated reservoir of large amounts of training data can be infeasible or at least very costly in terms of resource usage such as computer memory usage and also in terms of human time and effort to provide labels for the training data.

One solution to the challenge of collecting and storing a dedicated reservoir of large amounts of training data can be to leverage data that already exists within other systems as training data for a ML model. For example, some ancillary systems already contain a large amount of data such as user-generated data that can serve as a rich source for model training. As one example, user-generated content such as human-generated captions from an online video service (e.g., YouTube) can be used to train automated speech recognition (ASR) models (e.g., in which the input to the model is an audio sample comprising a spoken utterance, and the output of the model is a text comprising a transcription of the spoken utterance) or neural machine translation (NMT) models (e.g., in which the input to the model is text and/or an audio sample in a first language, and the output of the model is text and/or an audio sample in a second language).

However, one important limitation of using data (e.g., user-generated data) from other systems is that handling of such data typically must comply with data storage and handling policies associated with such systems. As one example, various types of user-generated content may be subject to user preferences or controls on usage of such data. For example, a user may be provided with controls allowing the user to make an election as to both if and when their user-generated content is able to be used to improve services (e.g., to be used as training data for a model). Furthermore, such data may also be updated by replacing the sets of data with updated versions (for example, due to changing user preferences, changes in the availability of content, correction of errors, and/or the like).

In particular, example approaches provided herein leverage large data pools available from various ancillary systems. Examples of such ancillary systems can include video services (e.g., YouTube), speech audio logs, historical search queries in web search services, historical navigational queries in mapping services, photograph storage services, electronic mail services, or, more generally, usage logs for various Internet-related products. In particular, a user may be provided with controls allowing the user to make an election as to both if and when systems, programs, or features described herein may enable collection of user information. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

As such, in certain situations, a user of such services can consent to the use of their data for improving various systems (e.g., training machine learning models). Thereafter, the user may delete their data and/or change their preferences so that the data may no longer be used for improving various systems (e.g., training machine learning models). This results in a continuously changing pool of data for use in training machine learning models.

In other examples, data may become unavailable for any number of other reasons, such as offensiveness, channel removal, change in underlying labeling models, and/or a change in metadata or “derived data”. For example, the labels applied to a training example may be automatically applied using a separate ML labelling model. A change in this underlying labelling model can result in the training example changing so that the previous training example does not exist in the same form. Additionally or alternatively, additional labels may become available which may change the training example. Thus, in addition or alternatively to user-caused deletion, training examples may shift or change in scope or availability for a number of other reasons.

Thus, the set of data in various systems that is usable for training a ML model may change over time. For example, a user may initially set preferences or controls that enable data to be used for training a ML model. However, the user may later change their preferences or controls so that the data is no longer available for training the ML model. Thus, data in various systems may be preference-compliant, meaning that if a user removes their content or otherwise adjusts preferences, all copies of that content may be required to be removed from every system, including systems that train models on the data. This precludes the use of such data as a static baseline for training and evaluating models, especially ones that are improved over time. In addition, there are various other scenarios in which data may be “ephemeral” or otherwise only available for use as training data for limited periods of time.

Because of the continuous change in training data, it can be difficult to directly compare or benchmark two models against each other—or more generally to understand the performance (e.g., accuracy, recall, etc.) of a model over time. For example, because data can be removed from the test set (which can come from all data available, not just special data), measured performance may change, even if the model has not changed.

In view of the above, the present disclosure provides systems and methods for interpreting model performance in view of shifting test and/or training data and/or training models on this shifting data as well (e.g., not just measuring model performance). In particular, in some example approaches which account for this possibility of changes in the availability of the ancillary data, a model training system can first gather a set of samples and their labels from a corpus of ancillary system data such as user-generated data. This data can be stored using a wipeout-compliant flag such that the data automatically expires (e.g., is deleted) after the appropriate amount of time (e.g., the earlier of usage in training or expiration of a predefined period of time).

The model training system can train an initial model on this dataset and measure its performance. The model training system can then optionally delete the initial dataset and collect a new set of data, fine-tuning the model on this new set. This process can be repeated immediately or, for example, periodically (e.g., every week or so), leading to a model that constantly evolves and adapts to new data without retaining any of the training data (e.g., without retaining any of the data in the initial dataset). This process also yields a history of multiple versions of the model, and each of these could be updated on each new dataset to evaluate the best candidate. This could be useful if there are different trends or cycles in the data over time such as many queries on a given topic in a given season of the year, based on day of the week, etc.

In some implementations, the base model may also be trained in a different set up than fine-tuned versions (e.g. combining self-supervised pretraining with supervised fine tuning). In some implementations, rather than keeping all past versions of a model, the versions of the model could be sampled—e.g. to only keep N. These might be the most recent, the highest quality (on the test set), or otherwise selected to encourage diversity.

A number of options exist for how to sample the data from a larger corpus for the training step. In one example, the samples can be randomly sampled from the entire corpus. This random sampling approach has the advantage that the data distribution reflects the underlying distribution of the corpus. Another potential approach is training a new model from scratch—e.g. if the data distribution changes significantly (and there's enough data in the new batch) then it may be better to start from scratch again.

It is possible, however, that future sampling stages will pull in some samples that have already been seen, which could be undesirable in some applications. Because the previous data is continuously deleted, the model would be unable to determine whether a sample has been previously encountered. Therefore, in some implementations, a hash of each training example can be retained and compared to hashes generated from newly sampled training examples. If the hashes match, the new sample can be rejected as a duplicate. In such fashion, duplicate samples can be avoided. However, in this example approach, the underlying data examples themselves are not retained or recoverable from the hashes. This approach has a number of benefits. As one example, the computing system can save on storage because an example was reduced down to only its hash. In addition, the system can avoid training the model on examples which it already encountered (saving processing costs). Furthermore, if a particular sample is seen multiple times, its impact on the model will be higher. This is undesirable because each sample should have the same weight and none of them should dominate just because they were randomly chosen more often than others. Therefore, the described approaches which avoid duplicate samples avoid this undesirable outcome.

In another instance of the sampling approach, the training system may only train the model on data from a given time window. For example, if the model is fine-tuned once per week, it could be updated using only samples that have become available in the past week. This will enable the model to be continually adapted over time as new samples are encountered, and it will implicitly avoid reusing samples. This approach could be implemented in a couple of ways. As one example, the computing system can accumulate data once per week and do a training run. As another example, the computing system can continuously train on data as it arrives or otherwise becomes available and then emit new model candidates each week.

In another example, samples that are outliers or that otherwise do not meet certain criteria can be rejected. For example, when sampling videos, a maximum video length can be established and sampled videos that exceed the maximum length can be rejected.

Another variant of the sampling approach applies when there are not enough data examples to train on. This situation is problematic because old data may be unavailable by the time new data arrives, so models that require a lot of data may encounter situations in which there is always an insufficient volume of training data. One example system overcomes this problem by using all currently available samples for training, and then updating the model as new data arrives. For example, online learning approaches can be used to train the model on new data as it arrives. This makes the best use of the currently available data at any given moment without having to wait for more data to arrive.

This process to train on new data as it arrives is in some respects akin to training on partial data. For example, it is known that some algorithms such as K-means or Gaussian Naive Bayes can be trained on partial data in batches and that the final model is exactly the same as if it had been trained with the full corpus of data from the start. Alternatively, the new sets of data encountered by the algorithm can be viewed as different training batches, and the learning rate can be modified accordingly to give sufficient weight to new batches of data relative to the older batches already seen by the model. For example, the learning rate can be adaptively scaled as a function of batch size. In another example, if the model architecture is changed at a given time, the new model can be distilled from the old architecture to the new to avoid starting from scratch.

After each training (or “re-training”) of the model, several approaches exist for evaluation of the trained model. In one instance, a “gold” test set is built that consists of carefully selected and annotated samples. This provides a good measure of the performance of the trained model on samples chosen by hand. Collecting such a dataset is reasonable in terms of human time and labor since test sets can be relatively small as opposed to the daunting task of collecting manually-labeled training samples.

In another example approach to building an evaluation set, the evaluation or test set could be automatically selected from the corpus in the same way that the training data was collected. Thus, even if the trained model did not change at all, the measured performance on the test dataset could change because the test data changed. To mitigate or account for this change in performance, statistical tests can be employed for measuring the expected deviation given a change in test set from the same distribution as a previous run.

In particular, statistical tests can, for example, be measured upfront to generate confidence intervals by evaluating a given trained model on multiple sets of randomly selected test sets. Then, when a new model is trained, its performance can be compared with the previous model or models, all of which can be evaluated on the same randomly-selected test set(s) in order to determine if the new model performs statistically better than the previous model(s). Then the new model can be accepted if it does perform better than the previous one(s).

As one example, the statistical tests can include determining a mean and standard deviation of the model performance on a test set. Other example statistical tests include min or max score, skew, quartile ranges, a degree to which a distribution (e.g., Gaussian) fits to the performance of the model, etc. Each of these statistical tests can provide or contribute to generation of a set of error bounds. Later performance (e.g., by the same model or a newly trained model) outside of these error bounds can indicate that an error has occurred in the model training process or that additional review is required.

Thus, in some examples, the following example approach can be used to evaluate model performance relative to continuously changing test or training data: A model can be trained on training examples sampled from a pool of ancillary data. A set of test examples can also be obtained (e.g., sampled from the pool). Statistical test(s) can be performed on the trained model using the set of test examples to generate a set of error bounds. These error bounds can be stored. The model can then be re-trained (e.g., on changed training data). The set of test examples may also be updated. The re-trained model can then be evaluated on the set of test examples to generate a new set of error bounds. This new set of error bounds can be compared to the previous set of error bounds to evaluate the relative performance of the model. For example, if the new set of error bounds significantly deviates from the previous set of error bounds, then the system can revert to the previous version of the model (e.g., prior to the re-training).

According to another aspect, feature information about test samples can be used to normalize performance scores. For example, statistical relationships between feature values and error bounds can be established and these statistical relationships can be used to normalize performance scores to better compare the performance of one or more models over two or more different test sets.

The proposed combinations of training and testing configurations on continuously changing data enable a wide-range of applications that depend on either very large, sensitive, and/or ephemeral data, and they enable continuous monitoring of the model performance without having to explicitly build and retain expensive static training and testing sets. In some example applications, human-generated captions from services such as YouTube can be used to train automated speech recognition (ASR) models or neural machine translation (NMT) models. Other examples include training Natural Language Processing (NLP) models on user queries or training image processing models such as models for object detection using user images.

The systems and methods of the present disclosure provide a number of technical effects and benefits. As one example, the proposed techniques enable reduced usage of computer memory resources. In particular, typical approaches for training ML models include collecting and storing a large amount of data dedicated solely for the purpose of training the model. Collection and storage of a dedicated reservoir of large amounts of training data can be infeasible or at least very costly in terms of resource usage such as computer memory usage. By enabling reliable training of ML models on data stored by ancillary systems, which store data for other ancillary purposes, the need to store a dedicated reservoir of training data can be eliminated. This results in reduced usage of computer memory resources.

As another example technical effect, the proposed techniques provide improved model performance. In particular, by enabling an improved understanding of and techniques for evaluating model performance over time on shifting data, the present disclosure can result in the ability to select a model that truly provides the best performance, even if results from a particular set of testing data indicates otherwise. Thus, model performance can be improved, which corresponds to improved functionality of the computer system itself.

The proposed systems and methods are also relevant in an on-device setting—for instance, a resource constrained phone or watch might not have much storage available so it could benefit from the techniques proposed herein for local training and/or personalization of its models.

With reference now to the Figures, example embodiments of the present disclosure will be discussed in further detail.

### Example Methods

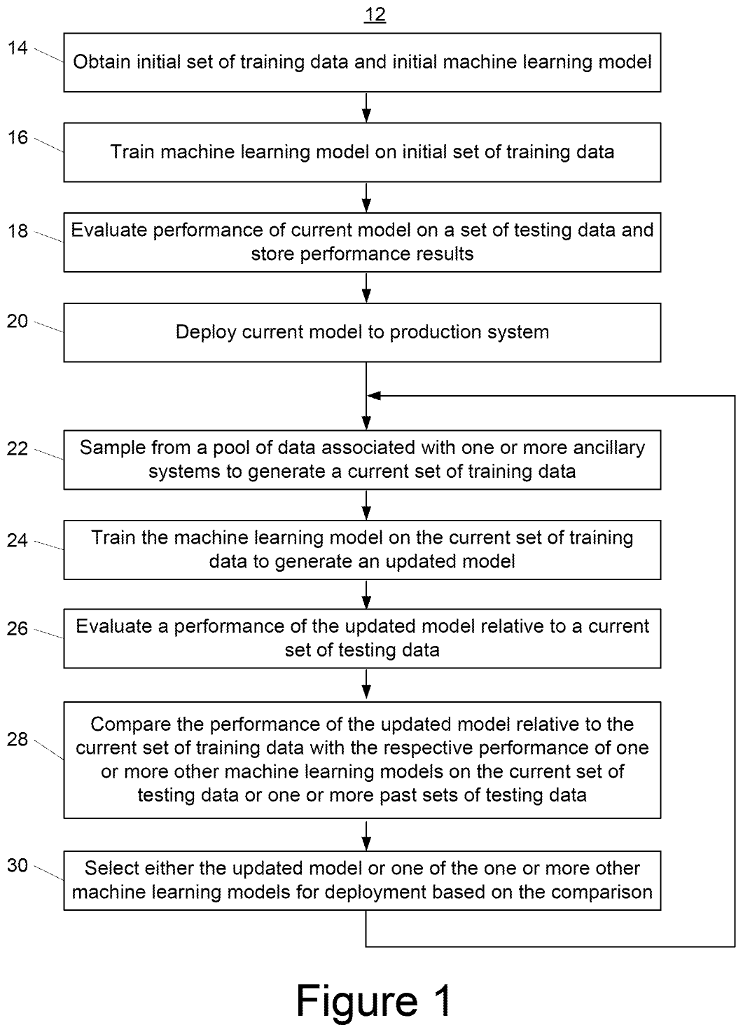

FIG. 1 depicts a flow chart diagram of an example method 12 to perform training and evaluation of machine learning models on changing data according to example embodiments of the present disclosure. Although FIG. 1 depicts steps performed in a particular order for purposes of illustration and discussion, the methods of the present disclosure are not limited to the particularly illustrated order or arrangement. The various steps of the method 12 can be omitted, rearranged, combined, and/or adapted in various ways without deviating from the scope of the present disclosure.

At 14, a computing system can obtain an initial set of training data and an initial machine learning model. The initial set of training data can be a dedicated set of training data or can be data accessed from ancillary systems, for example using techniques described below with respect to 22. At 16, the computing system can train the machine learning model on the initial set of training data.

At 18, the computing system can evaluate a performance of the current model on the set of testing data and can store the performance results. The testing data can be fixed testing data or testing data sampled at the time of performance evaluation, for example using techniques described below with respect to 26. The performance measures can be any form of performance measures such as accuracy, precision, recall, regression metrics, etc. The performance measures can also include any number of statistical tests. The statistical tests can be evaluated on the output of the model itself or on various performance measures of the output of the model. Example statistical tests include mean and/or standard deviation of the scores, min or max score, skew, quartile ranges, a degree to which a distribution (e.g., Gaussian) fits to the performance of the model, etc. Furthermore, error bounds can be determined for the performance measures and/or statistical tests. The performance evaluations can be stored for later use (e.g., at 28 as described below). A copy of the model can also be stored (e.g., for use at 30 as described below). In some implementations, the initial set of training data can be deleted.

At 20, the computing system can deploy the current model to a production system. The model can operate to provide predictions used by the production system. Some period of time may pass between operations 20 and 22 (e.g., a day, a week, a month, etc.).

At 22, the computing system can sample from a pool of data associated with one or more ancillary systems to generate a current set of training data. In some implementations, the pool of data associated with the one or more ancillary systems comprises user-generated content that is subject to user-defined handling obligations. In some implementations, one or more application programming interfaces can be used to access the data from the ancillary system(s).

More particularly, example approaches provided herein leverage large data pools available from various ancillary systems. Examples of such ancillary systems can include video services (e.g., YouTube), speech audio logs, historical search queries in web search services, historical navigational queries in mapping services, photograph storage services, electronic mail services, or, more generally, usage logs for various Internet-related products. In particular, a user may be provided with controls allowing the user to make an election as to both if and when systems, programs, or features described herein may enable collection of user information. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Thus, in some implementations, the method 12 can further include: associating a wipeout-compliant flag with the current set of training data, wherein the wipeout-compliant flag causes deletion of the current set of training data upon occurrence of a condition. The computing system can then delete the current set of training data upon occurrence of the condition. In one example, the condition can include the earlier of usage in training or expiration of a predefined period of time. In such fashion, the training data can automatically expire (e.g., be deleted) after the appropriate amount of time

Referring again to FIG. 1, a number of options exist for how to sample the training data at 22. In one example, the samples can be randomly sampled from the entire pool of data. This random sampling approach has the advantage that the data distribution reflects the underlying distribution of the corpus.

It is possible, however, that future iterations of operation 22 will pull in some samples that have already been seen, which could be undesirable in some applications. Because the previous data is continuously deleted, the model would be unable to determine whether a sample has been previously encountered. Therefore, in some implementations, a hash of each sampled training example can be generated and stored. Hashes generated from newly sampled training examples can be compared to hashes from previously sampled training examples. If the hashes match, the new sample can be rejected as a duplicate. In such fashion, duplicate samples can be avoided. However, in this example approach, the underlying data examples themselves are not retained or recoverable from the hashes.

In another example sampling approach, the computing system may only train the model on data from a given time window. For example, if the model is fine-tuned once per week, it could be updated using only samples that have become available in the past week. Thus, in some implementations, the sampling performed at 22 can include sampling, by the computing system and from the pool of data associated with the one or more ancillary systems, only data examples that have been newly generated within a defined period of time (e.g., the past day, week, month, etc.). This will enable the model to be continually adapted over time as new samples are encountered, and it will implicitly avoid reusing samples.

In another example, at 22, samples that are outliers or that otherwise do not meet certain criteria can be rejected. For example, when sampling videos, a maximum video length can be established and sampled videos that exceed the maximum length can be rejected.

At 24, the computing system can train the machine learning model on the current set of training data to generate an updated model.

At 26, the computing system can evaluate a performance of the updated model relative to a current set of testing data.

In some implementations, the current set of testing data can be a fixed set of testing data that is re-used at each iteration (e.g., at each instance of operation 26).

In other implementations, the current set of testing data can be different set of testing data at each (or at least at some) iterations. For example, at each instance of operation 26, the method 12 can also include sampling, by the computing system, from the pool of data associated with the one or more ancillary systems to generate the current set of testing data. For example, the same or different sampling techniques described with respect to operation 22 can be used to sample the testing data at 26.

Evaluating the performance of the updated model at 26 can include evaluating one or more performance measures. The performance measures can be any form of performance measures such as accuracy, precision, recall, regression metrics, etc. The performance measures can also include any number of statistical tests. The statistical tests can be evaluated on the output of the model itself or on various performance measures of the output of the model. Example statistical tests include mean and/or standard deviation of the scores, min or max score, skew, quartile ranges, a degree to which a distribution (e.g., Gaussian) fits to the performance of the model, etc. Furthermore, error bounds can be determined for the performance measures and/or statistical tests. The performance evaluations can be stored for later use (e.g., at a future iteration of 26). A copy of the model can also be stored

At 28, the computing system can compare the performance of the updated model relative to the current set of training data with the respective performance of one or more other machine learning models on the current set of testing data or one or more past sets of testing data.

In some implementations, the one or more other machine learning models can be or include previous checkpoints of the machine learning model. For example, the current model and/or its performance data at each iteration can be stored. Alternatively or additionally, the one or more other machine learning models can be or include wholly different models (e.g., models that are not in the same training lineage as the current model).

In some implementations, the performance comparison at 28 can include comparing the performance of the current model on the current set of testing data with the performance of one or more other models on the current set of testing data. Thus, the current model can be compared with other model(s) in a like-for-like basis. In these implementations, the performance measures, statistical tests, etc. can be directly compared to understand relative model performance. Alternatively or additionally, error bounds can be compared to understand relatively model performance.

Alternatively, or additionally, the performance comparison at 28 can include comparing the performance of the current model on the current set of testing data with the performance of one or more other models on one or more past sets of testing data. Thus, the current model can be compared with other model(s) based on different sets of testing data. In these implementations, additional information such as error bounds associated with the performance measures, statistical tests, etc. can be used to understand relative model performance. Additionally or alternatively, the performance measures, statistical tests, etc. can be directly compared. Additionally or alternatively, a moving average and/or trend lines associated of past variant(s) of the model on past set(s) of testing data can be used to understand whether the performance of the model matches or deviates from past performance or trends in past performance.

At 30, the computing system can select either the updated model or one of the one or more other machine learning models for deployment based on the comparison performed at 28. For example, in some implementations, the model that performed best on the current set of testing data can be selected and deployed to the production system. In another example, the current model can be selected for deployment unless its performance deviates from (e.g., is worse than) a first baseline (e.g., an average of other model performance(s) on the current set of testing data) by greater than a first threshold amount. Additionally or alternatively, the current model can be selected for deployment unless its performance deviates from (e.g., is worse than) a second baseline (e.g., an average of other model performance(s) on past set(s) of testing data) by greater than a second threshold amount. In some implementations, the second threshold amount can be greater than the first threshold amount. In some implementations, the deviation measured for the first threshold can be evaluated relative to raw performance measures, statistical tests, etc. In some implementations, the deviation measured for the second threshold can be evaluated relative to error bounds associated with the performance measures, statistical tests, etc.

After 30, the method 12 can return to operation 22. Some period of time may pass between operations 30 and 22 (e.g., a day, a week, a month, etc.).

### Example Devices and Systems

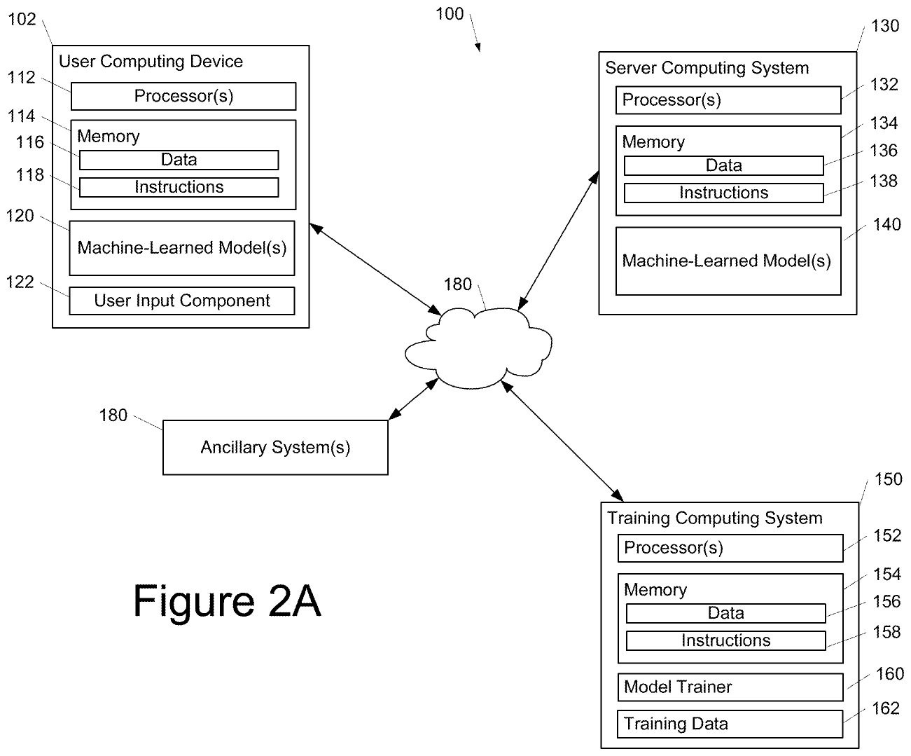

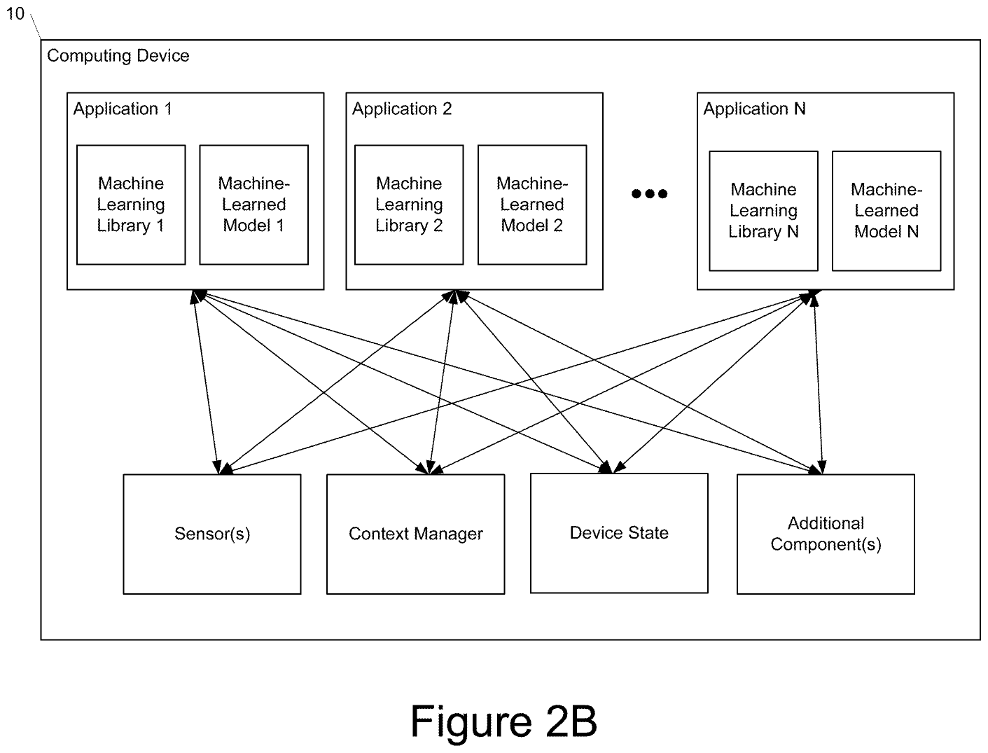

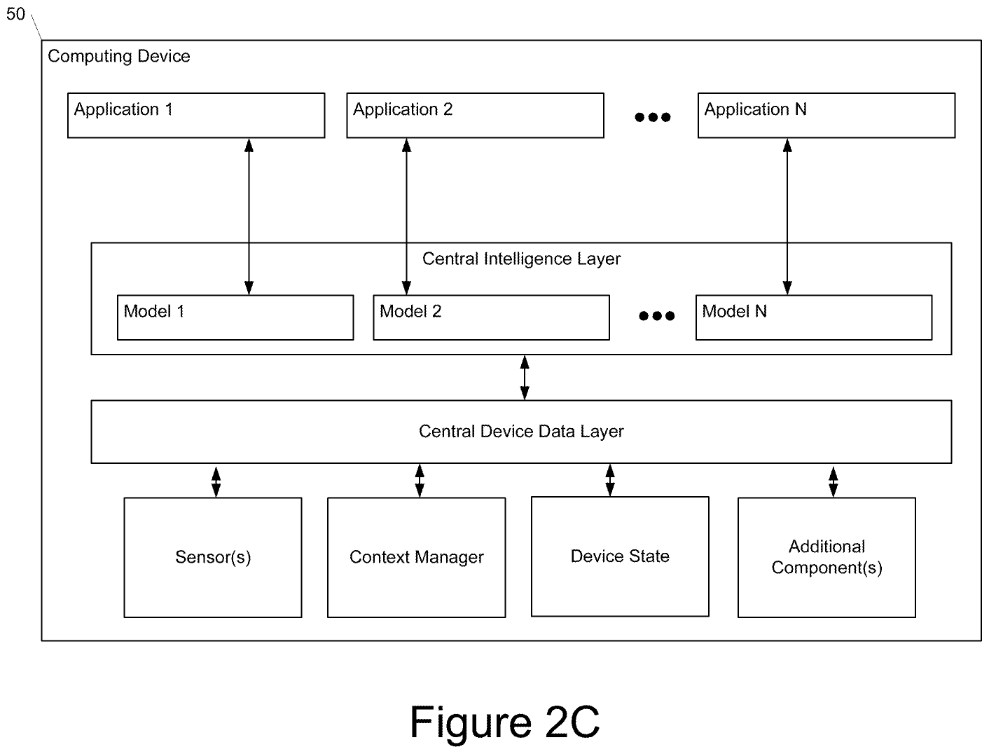

FIG. 2A depicts a block diagram of an example computing system 100 that performs training and evaluation of machine learning models on changing data according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean and/or standard deviation of the scores, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, data accessed from one or more ancillary systems 180. Ancillary systems 180 can include various operational systems that store data that has a primary purpose other than serving as training data for a machine learning model. Example ancillary systems can include web search systems (e.g., for imagery, web documents, books, scholarly works, etc.), travel systems, news systems, advertising systems, retail systems, video hosting systems, electronic mail systems, office productivity systems, file hosting systems, video, voice, or textual communications systems, mapping systems, web or software development systems, etc. Data from ancillary systems 180 can be handled and used in accordance with user controls, settings, and/or preferences.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The training computing system 150 and/or server computing system 130 can perform some or all of the method 12 of FIG. 1.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 2A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 2B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to train machine learning models on changing data, the method comprising:
for each of one or more update iterations:
sampling, by a computing system comprising one or more computing devices, from a pool of data associated with one or more ancillary systems to generate a current set of training data;
training, by the computing system, a machine learning model on the current set of training data to generate an updated model;
evaluating, by the computing system, a performance of the updated model relative to a current set of testing data;
performing, by the computing system, a comparison of the performance of the updated model relative to the current set of testing data with a respective performance of one or more other machine learning models on the current set of testing data or one or more past sets of testing data; and
selecting, by the computing system, either the updated model or one of the one or more other machine learning models for deployment based on the comparison of the performance of the updated model relative to the current set of testing data with the respective performance of the one or more other machine learning models on the current set of testing data or the one or more past sets of testing data.

2. The computer-implemented method of claim 1, further comprising, for each of the one or more update iterations, sampling, by the computing system, from the pool of data associated with the one or more ancillary systems to generate the current set of testing data.

3. The computer-implemented method of claim 1, wherein the current set of testing data comprises a fixed set of testing data.

4. The computer-implemented method of claim 1, wherein the one or more other machine learning models comprise previous checkpoints of the machine learning model.

5. The computer-implemented method of claim 1, wherein the pool of data associated with the one or more ancillary systems comprises user-generated content that is subject to user-defined handling obligations.

6. The computer-implemented method of claim 1, wherein sampling, by the computing system, from the pool of data associated with the one or more ancillary systems to generate the current set of training data comprises:
associating, by the computing system, a wipeout-compliant flag with the current set of training data, wherein the wipeout-compliant flag causes deletion of the current set of training data upon occurrence of a condition; and
deleting, by the computing system, the current set of training data upon occurrence of the condition.

7. The computer-implemented method of claim 1, wherein sampling, by the computing system, from the pool of data associated with the one or more ancillary systems to generate the current set of training data comprises:
randomly sampling, by the computing system, from the pool of data associated with the one or more ancillary systems to generate the current set of training data.

8. The computer-implemented method of claim 1, wherein sampling, by the computing system, from the pool of data associated with the one or more ancillary systems to generate the current set of training data comprises:
sampling, by the computing system and from the pool of data associated with the one or more ancillary systems, only data examples that have been newly generated within a defined period of time.

9. The computer-implemented method of claim 1, wherein performing, by the computing system, the comparison of the performance of the updated model relative to the current set of testing data with the respective performance of the one or more other machine learning models on the current set of testing data or the one or more past sets of testing data comprises:
determining, by the computing system, a first set of statistical tests for the performance of the updated model relative to the current set of testing data;
determining, by the computing system, a second set of statistical tests for the respective performance of the one or more other machine learning models on the current set of testing data; and
performing, by the computing system, a comparison of the first set of statistical tests and the second set of statistical tests.

10. The computer-implemented method of claim 1, wherein performing, by the computing system, the comparison of the performance of the updated model relative to the current set of testing data with the respective performance of the one or more other machine learning models on the current set of testing data or the one or more past sets of testing data comprises:
determining, by the computing system, a first set of statistical tests for the performance of the updated model relative to the current set of testing data;
determining, by the computing system, a second set of statistical tests for the respective performance of the one or more other machine learning models on the one or more past sets of testing data; and
performing, by the computing system, a comparison of the first set of statistical tests and the second set of statistical tests.

11. The computer-implemented method of claim 9, wherein the first set of statistical tests and the second set of statistical tests each comprise a set of error bounds.

12. The computer-implemented method of claim 9, wherein the first set of statistical tests and the second set of statistical tests each comprise one or more of:
mean or standard deviation;
min or max score;
skew;
quartile ranges; or
a degree to which a distribution fits to the performance of the model.

13. The computer-implemented method of claim 10, wherein performing, by the computing system, the comparison of the first set of statistical tests and the second set of statistical tests comprises normalizing at least the first set of statistical tests based on feature values associated with the current set of testing data.

14. The computer-implemented method of claim 1, further comprising:
providing, by the computing system, an automated alert when the performance of the updated model relative to the current set of testing data deviates from the respective performance of the one or more other machine learning models on the current set of testing data.

15. The computer-implemented method of claim 1, wherein sampling, by the computing system, from the pool of data associated with the one or more ancillary systems to generate the current set of training data comprises:
accessing, by the computing system, the one or more ancillary systems using one or more application programming interfaces.

16. A computing system for training machine learning models on changing data, the computing system comprising:
one or more processors; and
one or more non-transitory computer-readable media that collectively store instructions that, when executed by the one or more processors, cause the computing system to perform operations for each of one or more update iterations, the operations comprising:
sampling, by the computing system, from a pool of data associated with one or more ancillary systems to generate a current set of training data;
training, by the computing system, a machine learning model on the current set of training data to generate an updated model;
evaluating, by the computing system, a performance of the updated model relative to a current set of testing data; and
performing, by the computing system, a comparison of the performance of the updated model relative to the current set of testing data with a respective performance of one or more other machine learning models on the current set of testing data or one or more past sets of testing data.

17. The computing system of claim 16, wherein the operations further comprise:
selecting, by the computing system, either the updated model or one of the one or more other machine learning models for deployment based on the comparison of the performance of the updated model relative to the current set of testing data with the respective performance of the one or more other machine learning models on the current set of testing data.

18. The computing system of claim 16, wherein sampling, by the computing system, from the pool of data associated with the one or more ancillary systems to generate the current set of training data comprises:
associating, by the computing system, a wipeout-compliant flag with the current set of training data, wherein the wipeout-compliant flag causes deletion of the current set of training data upon occurrence of a condition; and
deleting, by the computing system, the current set of training data upon occurrence of the condition.

19. The computing system of claim 16, wherein performing, by the computing system, the comparison of the performance of the updated model relative to the current set of testing data with the respective performance of the one or more other machine learning models on the current set of testing data or the one or more past sets of testing data comprises:
determining, by the computing system, a first set of statistical tests for the performance of the updated model relative to the current set of testing data;
determining, by the computing system, a second set of statistical tests for the respective performance of the one or more other machine learning models on the current set of testing data; and
performing, by the computing system, a comparison of the first set of statistical tests and the second set of statistical tests.

20. One or more non-transitory computer-readable media that collectively store instructions that, when executed by a computing system, cause the computing system to perform operations for each of one or more update iterations, the operations comprising:
sampling, by the computing system, from a pool of data associated with one or more ancillary systems to generate a current set of training data;
training, by the computing system, a machine learning model on the current set of training data to generate an updated model;
evaluating, by the computing system, a performance of the updated model relative to a current set of testing data; and
performing, by the computing system, a comparison of the performance of the updated model relative to the current set of testing data with a respective performance of one or more other machine learning models on the current set of testing data or one or more past sets of testing data.
